(19) United States
(12) Patent Application Publication
(10) Pub. No.: US 2016/0055926 A1
(43) Pub. Date: Feb. 25, 2016

(54) MULTI-THERMOCOUPLE IN-CORE INSTRUMENT ASSEMBLY AND SYSTEM AND METHOD FOR MONITORING INTERNAL STATE OF NUCLEAR REACTOR AFTER SEVERE ACCIDENT USING THE SAME

(71) Applicants: KOREA HYDRO & NUCLEAR POWER CO., LTD, Gyeongju (KR); WOOJIN INC., Hwaseong (KR)

(72) Inventors: Song Hae YE, Daejeon (KR); Yeong Cheol SHIN, Daejeon (KR); Soo Ill LEE, Daejeon (KR); Kwang Dae LEE, Gyeongju (KR); Hong Ki JUNG, Gyeongju (KR); Hee Taek LIM, Gyeongju (KR); Yong Sik KIM, Gyeongju (KR); Kye Hyeon RYU, Suwon (KR); Myung Eun CHAE, Seoul (KR); Sung Jin KIM, Siheung (KR)

(21) Appl. No.: 14/829,540

(22) Filed: Aug. 18, 2015

(30) Foreign Application Priority Data
Aug. 25, 2014 (KR) 10-2014-0111106
Aug. 25, 2014 (KR) 10-2014-0111111

(51) Int. Cl. G21C 17/112

(52) U.S. Cl. CPC G21C 17/112

(57) ABSTRACT

Disclosed herein are a multi-thermocouple in-core instrument assembly and a system and method for monitoring the internal state of a nuclear reactor after a severe accident using the in-core instrument assembly. In accordance with an embodiment of the present invention, a multi-thermocouple in-core instrument assembly includes a signal compensation detector, thermocouples, and a plurality of neutron detectors disposed between a center pipe having a circular section and an external protection pipe, and the thermocouples have temperature-measuring points at different heights.

Priority to Korean patent application number 10-2014-0111106 filed on Aug. 25, 2014 and 10-2014-0111111 filed on Aug. 25, 2014, the entire disclosure of which is incorporated by reference herein, is claimed.

### BACKGROUND OF THE INVENTION

1. Field of the Invention

The present invention relates to a multi-thermocouple in-core instrument assembly, which assists in diagnosing the internal state of a nuclear reactor more accurately by providing temperature information at different heights within the nuclear reactor using a plurality of thermocouples having temperature-measuring points at different heights, and a system and method of monitoring the internal state of a nuclear reactor after a severe accident using the in-core instrument assembly.

2. Discussion of the Related Art

A plurality of, for example, 61 in-core instrument assemblies are fixedly installed within a nuclear reactor provides support so that a neutron flux within the nuclear reactor can be accurately measured in three dimensions and an output distribution thereof can be monitored. A core element of the in-core instrument assembly is a self-powered neutron detector including an emitter for absorbing neutrons and emitting a signal current.

A conventional self-powered neutron detector using rhodium (Rh) is driven by the neutron capturing reaction principle of a rhodium emitter substance. When neutrons incident on rhodium are captured, they emit electrons of high energy having sufficient energy to the extent that the neutrons deviate from the emitter while experience beta decay. The emitted electrons are collected by a collector through an aluminum oxide (Al₂O₃) insulator, and positive charges are generated at a conductor attached to the emitter. The generated positive charges generate an electric current in proportion to the neutron absorption ratio of the emitter. The neutron detector is divided into a rhodium (Rh) detector, a vanadium (V) detector, a cobalt (Co) detector, and a platinum (Pt) detector depending on the materials of the emitter.

FIG. 1 is a front view of a conventional in-core instrument assembly. As illustrated in FIG. 1, the conventional in-core instrument assembly 10 includes a measurement unit 20, a seal plug 30, a flexible hose 40, and a connector. The measurement unit 20 surrounds an external protection pipe 25, and a bullet nose 26 is connected to one end of the measurement unit 20. The measurement unit 20 is inserted into a nuclear reactor through a guide tube (not illustrated), and has a length of about 36 m.

FIG. 2 is a longitudinal cross-sectional view taken along line A-A of FIG. 1. As illustrated in FIG. 2, the measurement unit 20 of the conventional in-core instrument assembly 10 is configured to include a center pipe 21, a thermocouple 22, a signal compensation detector 24, an external protection pipe 25, and neutron detectors 27.

In the aforementioned configuration, the center pipe 21 penetrates the inside of the measurement unit 20 in a length direction. The center pipe 21 has a hollow tube form in order to have the same diameter as a guide tube, and the length of the center pipe 21 has been approximately standardized. The thermocouple 22 includes a pair of cables having a circular section, that is, a chromel wire 22a and the alumel wire 22b, and is used to measure a temperature of a coolant within a nuclear reactor. A K type thermocouple is chiefly used as the thermocouple 22. The neutron detector 27 also has a cable form having a circular section. A total of five (strands of) neutron detectors 27 are used to measure a neutron flux within the nuclear reactor. A single (strand of) signal compensation detector 24 is implemented in a cable form having a circular section and used to measure a background signal (noise).

In this case, each of the neutron detectors 27, the thermocouple 22, and the signal compensation detector 24 (hereinafter collectively called the “detector”) have approximately the same length and diameter. The measurement unit 20 further includes a total of 8 (strands of) filler cables 23 for filling empty spaces in order to prevent the fluctuation of each detector attributable to a difference in the diameter between the center pipe 21 and the detector and to dispose each neutron detector 27 at a desired location (or angle) when the neutron detector 27, the thermocouple 22, and the signal compensation detector 24 are disposed to surround the center pipe 21 in the space between the center pipe 21 and the external protection pipe 25.

In accordance with the aforementioned conventional in-core instrument assembly, there is a problem in that the utilization of the in-core instrument assembly that is relatively expensive is low because a total of the eight filler cables are used to only prevent the fluctuation of each detector and to maintain the distance between the detectors.

Referring to FIG. 3, the conventional nuclear reactor in-core instrument assembly 10 is inserted into a nuclear reactor, and monitors a neutron flux within a reactor core and a temperature at the exit on top of the reactor core. The in-core instrument assembly 10 is inserted into a nuclear reactor 1001 through a guide tube 1005, and determines a temperature (650 degrees) at the exit on top of the reactor core to be a severe accident entry condition using a single K type thermocouple disposed at the end of the in-core instrument assembly 10.

That is, in the conventional in-core instrument assembly 10, if a severe accident occurs, information about a reactor core temperature is totally lost when a reactor core top 1002a is subjected to bad damage because only a temperature at the reactor core top 1002a is measured. Furthermore, it is impossible to measure the cooling, overheating, oxidation, and bad damage state of the entire reactor core (including the middle and bottom of the reactor core), the rearrangement of molten reactor core in the lower cavity 1001a and lower head 1001b of a nuclear reactor container on the lower side of the reactor core, and a direct distribution of temperatures for monitoring the deviation state of the nuclear reactor container.

Accordingly, there is a problem in that it is difficult to check the internal state of the nuclear reactor container for optimally handling a severe accident and to establish a strategy for handling an accident, such as cooling and the removal of hydrogen.

### PRIOR ART DOCUMENT

### Patent Document

Korean Patent Application Publication No. 10-2014-0010501 entitled “In-Core Instrument Assembly for Improvement of neutron flux detection sensitivity”

### SUMMARY OF THE INVENTION

An object of the present invention is to provide a multi-thermocouple in-core instrument assembly, which assists in diagnosing the internal state of a nuclear reactor more accurately by providing temperature information at different heights within the nuclear reactor using a plurality of thermocouples having temperature-measuring points at different heights.

Another object of the present invention is to provide a multi-thermocouple in-core instrument assembly, which is capable of maximizing the utilization of an apparatus by providing temperature information at different heights within a nuclear reactor using a plurality of thermocouples having temperature-measuring points at different heights instead of filler cables.

Yet another object of the present invention is to provide a system and method for monitoring the internal state of a nuclear reactor after a severe accident, which are capable of monitoring the cooling and overheating state of a reactor core in each part of a nuclear reactor core and the water level of a nuclear reactor container when a severe accident occurs.

Further yet another object of the present invention is to provide a system and method for monitoring the internal state of a nuclear reactor after a severe accident, which are capable of monitoring an oxidation state generated due to a hydration reaction between a reactor core in each part of a nuclear reactor core and steam when a severe accident is generated and a bad damage state in which the normal geometry of the reactor core is unable to be maintained.

Still yet another object of the present invention is to provide a system and method for monitoring the internal state of a nuclear reactor after a severe accident, which are capable of monitoring the amount of hydrogen at which a nuclear reactor may explode based on the amount of oxidation of each part of a reactor core when a severe accident occurs.

Still yet another object of the present invention is to provide a system and method for monitoring the internal state of a nuclear reactor after a severe accident, which are capable of monitoring the state in which molten reactor core has been rearranged in the lower cavity of a nuclear reactor container over time after a severe accident occurs and the state in which molten reactor core may deviate from a lower head.

An object of the present invention is achieved by a multi-thermocouple in-core instrument assembly, wherein the in-core instrument assembly includes a signal compensation detector, thermocouples, and a plurality of neutron detectors disposed between a center pipe having a circular section and an external protection pipe, and the thermocouples have temperature-measuring points at different heights.

The number of signal compensation detector is one, the number of neutron detectors is five, and the number of thermocouples is two to five. If four or less thermocouples are installed, the space in which the thermocouple is not installed may be filled with filler cables.

The thermocouple or the filler cables and the neutron detector may be alternately disposed.

An empty space may be filled with filler cables if the empty space is formed above the thermocouple.

Each of the thermocouples may be formed by bonding adjacent wires made of different materials.

The wires made of different materials may include a chromel wire and an alumel wire.

Another object of the present invention may be achieved by a system for monitoring the internal state of a nuclear reactor after a severe accident, including an in-core instrument assembly inserted into the nuclear reactor and configured to measure neutrons and a temperature within the nuclear reactor and a diagnostic unit configured to determine the state of the nuclear reactor based on a temperature measured by the in-core instrument assembly, wherein the in-core instrument assembly includes two or more thermocouples, and two or more in-core instrument assemblies are inserted and disposed in the nuclear reactor at a specific interval.

The two or more thermocouples may have different heights in a length direction.

The diagnostic unit may determine at least one of whether a reactor core has been damaged, the location of a damaged reactor core, the amount of hydrogen generated in the nuclear reactor, the state in which molten reactor core has been rearranged, and the time when molten reactor core penetrates the nuclear reactor based on a temperature measured by the two or more thermocouples.

At least one of whether the reactor core has been damaged, the location of the damaged reactor core, and the amount of hydrogen generated in the nuclear reactor may be determined based on the oxidation of the materials of the reactor core and the time during which the materials are exposed to a high temperature.

At least one of the state in which the molten reactor core has been rearranged and the time when the molten reactor core penetrates the nuclear reactor may be determined based on a temperature of a lower cavity under the nuclear reactor or a lower head.

An object of the present invention is achieved by a method for monitoring the internal state of a nuclear reactor after a severe accident using an in-core instrument assembly, including steps of (A) disposing two or more thermocouples in the in-core instrument assembly, (B) disposing the two or more thermocouples at different heights in a length direction, (C) inserting the two or more in-core instrument assemblies into the nuclear reactor, and (D) measuring temperatures at the different heights within the nuclear reactor through the thermocouples.

The method may further include a step of (E) determining at least one of whether a reactor core has been damaged, the location of a damaged reactor core, the amount of hydrogen generated in the nuclear reactor, the state in which molten reactor core has been rearranged, and the time when molten reactor core penetrates the nuclear reactor based on a temperature within the nuclear reactor measured the step (D).

At least one of whether the reactor core has been damaged, the location of the damaged reactor core, and the amount of hydrogen generated in the nuclear reactor may be determined based on the oxidation of the materials of the reactor core and the time during which the materials are exposed to a high temperature.

At least one of the state in which the molten reactor core has been rearranged and the time when the molten reactor core penetrates the nuclear reactor may be determined based on a temperature of a lower cavity under the nuclear reactor or a lower head.

### BRIEF DESCRIPTION OF THE DRAWINGS

FIG. 1 is a front view of a conventional in-core instrument assembly;

FIG. 2 is a longitudinal cross-sectional view taken along line A-A of FIG. 1;

FIG. 3 is a longitudinal cross-sectional view illustrating that a conventional in-core instrument assembly has been installed in a reactor core;

FIG. 4 is a front view of a multi-thermocouple in-core instrument assembly in accordance with an embodiment of the present invention;

FIG. 5 is a longitudinal cross-sectional view taken along line A-A of FIG. 4;

FIG. 6 is a structural diagram illustrating the state in which the inside of the multi-thermocouple in-core instrument assembly in accordance with an embodiment of the present invention has been deployed on a plane;

FIGS. 7 to 9 illustrate a system for monitoring the internal state of a nuclear reactor after a severe accident in the nuclear reactor in accordance with an embodiment of the present invention; and

FIG. 10 illustrates a system for monitoring the internal state of a nuclear reactor after a severe accident in the nuclear reactor in accordance with another embodiment of the present invention.

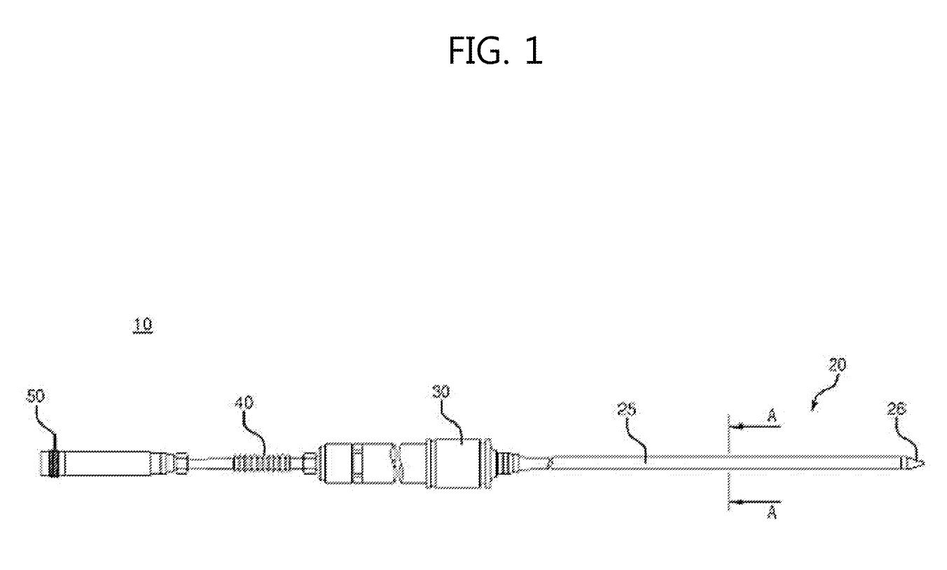

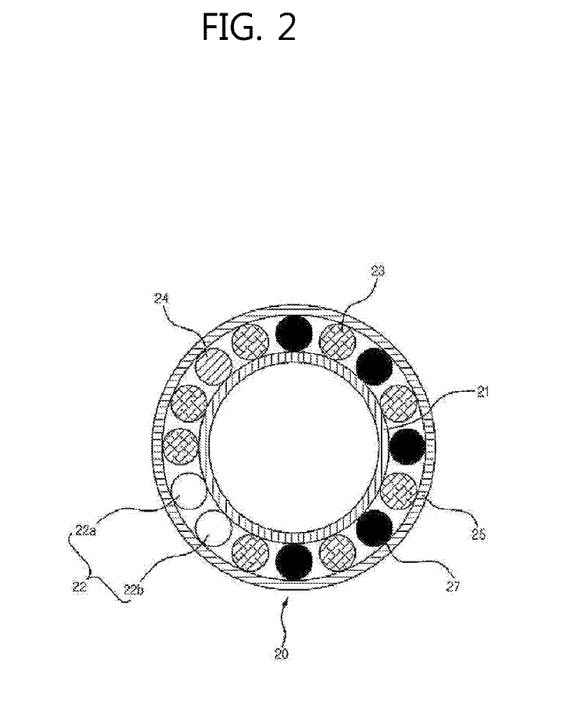

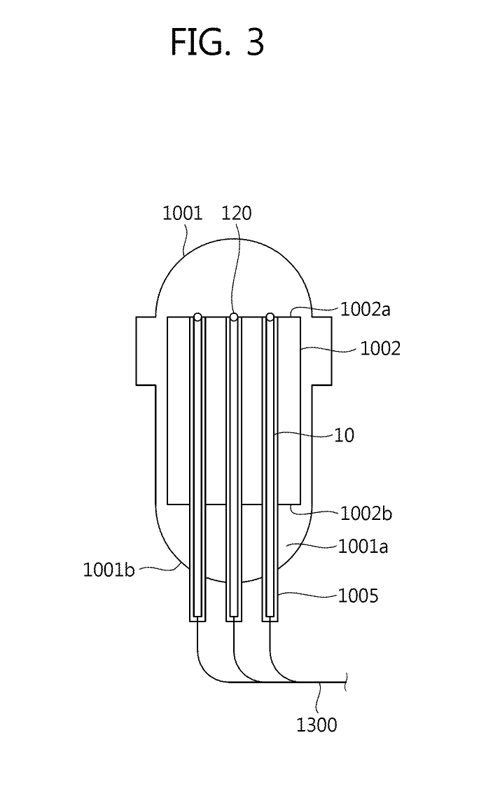

### DETAILED DESCRIPTION OF THE EMBODIMENTS

Hereinafter, embodiments of a multi-thermocouple in-core instrument assembly according to the present invention will be described in detail with reference to the accompanying drawings.

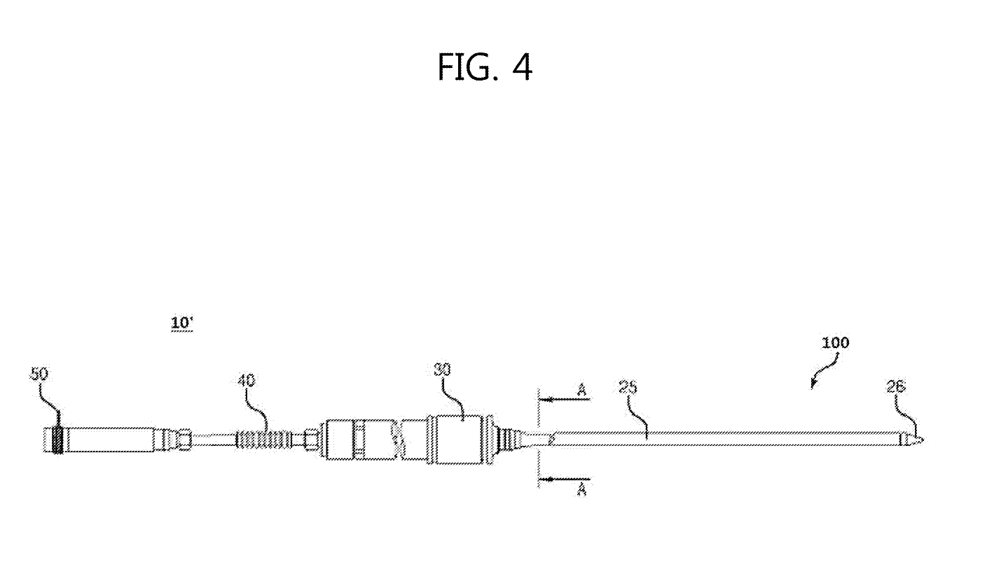

FIG. 4 is a front view of a multi-thermocouple in-core instrument assembly in accordance with an embodiment of the present invention. As illustrated in FIG. 4, the in-core instrument assembly 10′ including a multi-thermocouple in accordance with an embodiment of the present invention includes a measurement unit 100, a seal plug 30, a flexible hose 40, and a connector. The measurement unit 100 is surrounded by an external protection pipe 25. A bullet nose 26 is connected to one end of the measurement unit 100. The measurement unit 100 is inserted into a nuclear reactor through a guide tube (not illustrated), and has a length of about 36 m.

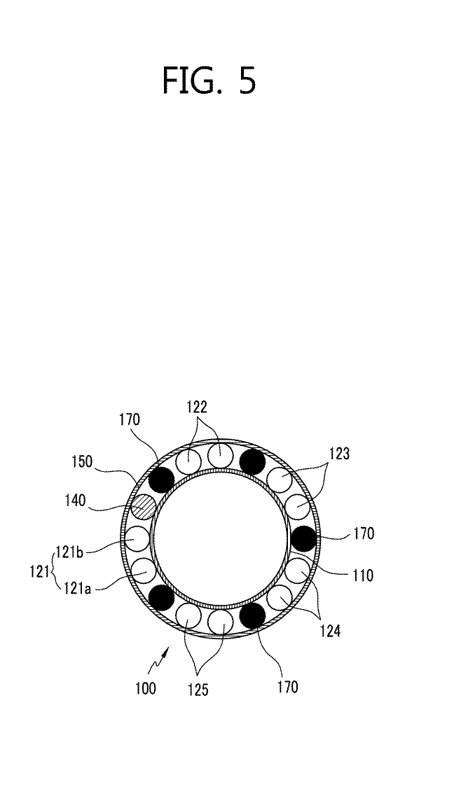

FIG. 5 is a longitudinal cross-sectional view taken along line A-A of FIG. 4. FIG. 5 is a longitudinal cross-sectional view of the lower part of the measurement unit 100 in the state in which the measurement unit 100 has been installed at a portion adjacent to the seal plug 30 of the measurement unit 100, that is, within the nuclear reactor. As illustrated in FIG. 5, the measurement unit 100 of the in-core instrument assembly in accordance with an embodiment of the present invention is basically configured to include a center pipe 110, a thermocouple 121, a signal compensation detector 140, an external protection pipe 150, and neutron detectors 170.

In the aforementioned configuration, the center pipe 110 penetrates the inside of the measurement unit 100 in the length direction of the measurement unit 100. The center pipe 110 is configured in the form of a hollow tube having a diameter to the extent that a fluctuation is not generated within a guide tube (not illustrated) because the center pipe 110 is inserted into the nuclear reactor through the guide tube. The length of the center pipe 110 has been approximately standardized. The neutron detector 170 is also implemented in a cable form having a circular section. A total of five (strands of) neutron detectors 170 are installed and used to measure a neutron flux within the nuclear reactor. A single (stand of) signal compensation detector 140 is also implemented in a cable form having a circular section and used to measure a background signal (or noise).

The multi-thermocouple in-core instrument assembly in accordance with an embodiment of the present invention may further include additional thermocouples 122˜125 in addition to the thermocouple 121 that is used to measure a temperature of a coolant within a conventional nuclear reactor. The additional thermocouples 122˜125 may include a maximum of 4 thermocouples because they may be included instead of a total of 8 filler cables included in a conventional in-core instrument assembly. In this case, in order to detect temperatures at different points (or heights) within the nuclear reactor, the thermocouples 121˜125 may have temperature-measuring points at different heights.

Furthermore, the chromel wire 121a and alumel wire 121b of each of the thermocouples 121˜125 need to be adjacently installed so that a contact point can be formed at the ends of the chromel wire and the alumel wire. The neutron detector 170 may be disposed between the thermocouples 121˜125 so that the influence of an electric field generated from the thermocouples 121˜125 is minimized and the neutron detectors 170 are disposed at equal intervals.

Each of the thermocouples 121˜125 includes a pair of cables having a circular section, that is, the chromel wire 121a and the alumel wire 121b. The thermocouple may be implemented using a K type thermocouple capable of detecting a temperature of 1260.

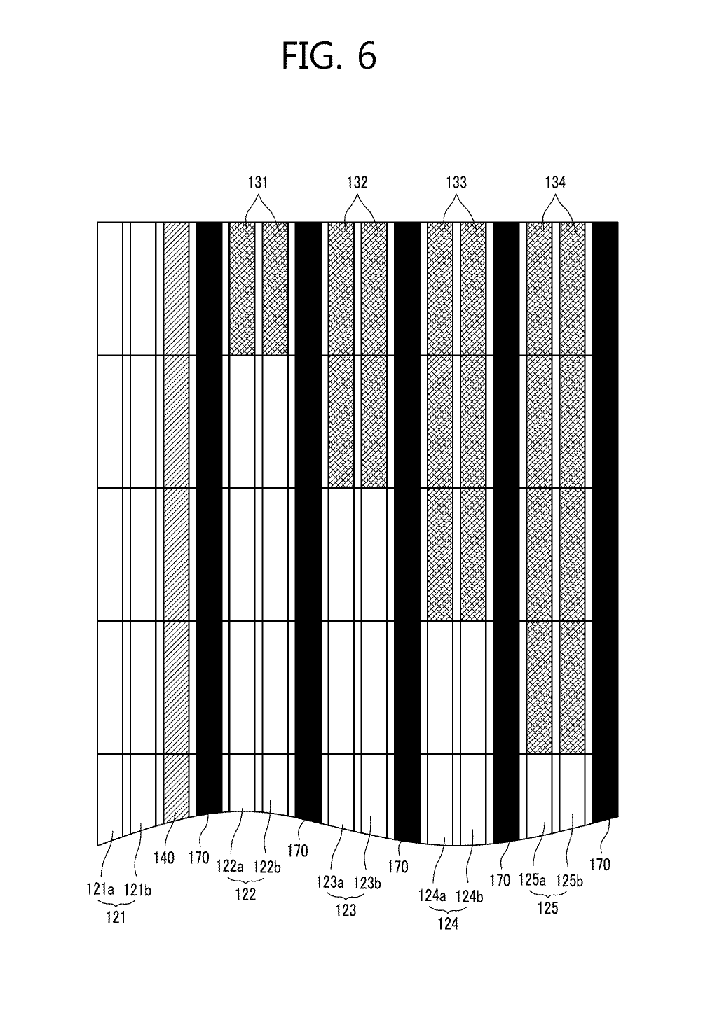

FIG. 6 is a structural diagram illustrating the state in which the inside of the multi-thermocouple in-core instrument assembly in accordance with an embodiment of the present invention has been deployed on a plane. As illustrated in FIG. 6, the multi-thermocouple in-core instrument assembly in accordance with an embodiment of the present invention may include a total of the five thermocouples 121˜125 having temperature-measuring points formed in the respective sections of a nuclear reactor in the state in which the inside of the nuclear reactor has been divided into five equal parts.

In this case, for example, the thermocouple 121 having the temperature-measuring point formed near the top of the measurement unit 100 does not have a fluctuation problem because the neutron detector 170 adjacent to the thermocouple 121 or the signal compensation detector 140 have almost the same length. In contrast, in each of the thermocouples 122˜125 having the temperature-measuring points formed at locations lower than the location of the temperature-measuring point of the thermocouple 121, a problem may occur in which the neutron detector 170 or the signal compensation detector 140 is fluctuated or bent through an empty space because the empty space is formed above each of the thermocouples 122˜125. In order to prevent such a problem, the empty spaces formed above the thermocouples 122˜125 having low temperature-measuring points may be filled with respective filler cables 131˜134. Accordingly, the filler cables 131˜134 may have different lengths, and a total length of the thermocouples 122˜125 and the filler cables 131˜134 may be the same as the length of the neutron detector 170 or the signal compensation detector 140.

Although an embodiment of the multi-thermocouple in-core instrument assembly according to the present invention has been described above, the embodiment is only illustrative, and the in-core instrument assembly in accordance with an embodiment of the present invention may be modified and changed in various ways without departing from the category of the technical spirit. Accordingly, the scope of the present invention should be determined by the claims.

For example, the number of thermocouples 121˜125 may be two˜four other than five. In this case, an empty space from which the thermocouple has been removed may be filled with conventional filler cables. The interval between the temperature-measuring points of the thermocouples 121˜125 and the length of the thermocouples 121˜125 may also be properly changed.

If a total of five thermocouples are included, two or three of the thermocouples may have temperature-measuring points having the same height in order to guarantee reliability of measurement results. Furthermore, the upper spaces of all the thermocouples may be empty. In this case, all the empty spaces may be filled with the filler cables. The thermocouple may include another type of thermocouple other than the K type.

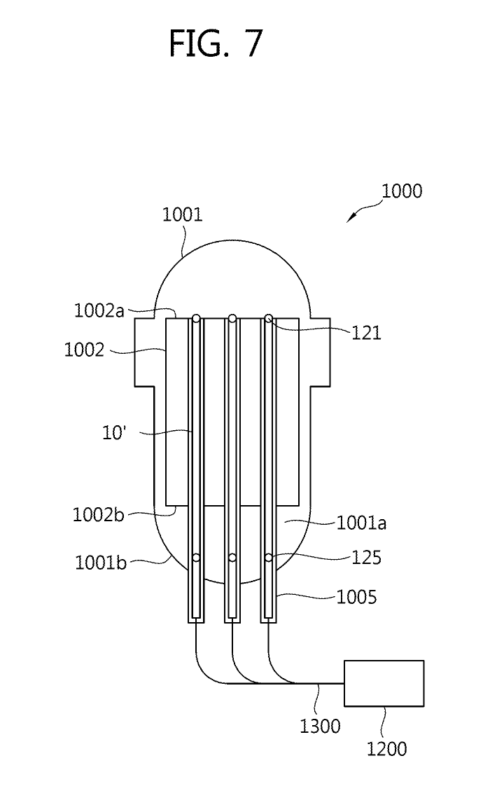

A system and method for monitoring the internal state of a nuclear reactor after a severe accident in accordance with embodiments of the present invention are described below with reference to FIGS. 7 to 10.

FIGS. 7 to 9 illustrate a system 1000 for monitoring the internal state of a nuclear reactor after a severe accident in the nuclear reactor in accordance with an embodiment of the present invention. Referring to FIGS. 7 to 9, the system for monitoring the internal state of a nuclear reactor after a severe accident in accordance with an embodiment of the present invention may include the in-core instrument assemblies 10′ and a diagnostic unit 1200.

The in-core instrument assembly 10′ in accordance with an embodiment of the present invention is inserted into a nuclear reactor 1001, and measures neutrons and a temperature within the nuclear reactor 1001. In this case, the in-core instrument assembly 10′ includes two or more thermocouples (e.g., a first thermocouple, a second thermocouple, and a fifth thermocouple).

Furthermore, the two or more thermocouples 121˜125 have different heights in the length direction of the thermocouple and can measure temperatures at the middle and/or lower part in addition to the top of a reactor core 1002.

At least two in-core instrument assemblies 10′ in accordance with an embodiment of the present invention are inserted into the nuclear reactor 1001 and may be disposed in the reactor core 1002 at a constant interval.

Referring to FIGS. 7 to 9, each of the in-core instrument assemblies 10′ may be inserted into the nuclear reactor through a guide tube 1005 installed at lower part of the nuclear reactor 1001.

The diagnostic unit 1200 in accordance with an embodiment of the present invention may determine the state of the nuclear reactor 1001 based on temperatures measured by the thermocouples 121˜125 of the in-core instrument assembly 10′. Referring to FIG. 7, a separate transmission cable 1300 connected to the end of the in-core instrument assembly 10′ is installed so that temperature information is transferred from the in-core instrument assembly 10′ to the diagnostic unit 1200 through the transmission cable 1300.

The diagnostic unit 1200 may determine at least one of the cooling, overheating, oxidation, bad damage, and melting state (e.g., the location and degree of melts) of the reactor core 1002, the rearrangement state of molten reactor core in the lower cavity 1001a of a nuclear reactor container, and a danger that molten reactor core may deviated from the lower head 1001b of the nuclear reactor container.

The system 1000 for monitoring the internal state of a nuclear reactor after a severe accident in accordance with an embodiment of the present invention may include the two or more in-core instrument assemblies 10′. The in-core instrument assemblies 10′ in accordance with an embodiment of the present invention may be installed in the reactor core 1002. In the system 1000 for monitoring the internal state of a nuclear reactor after a severe accident in accordance with an embodiment of the present invention, a total of the 61 in-core instrument assemblies 10′ may be inserted into the nuclear reactor 1001.

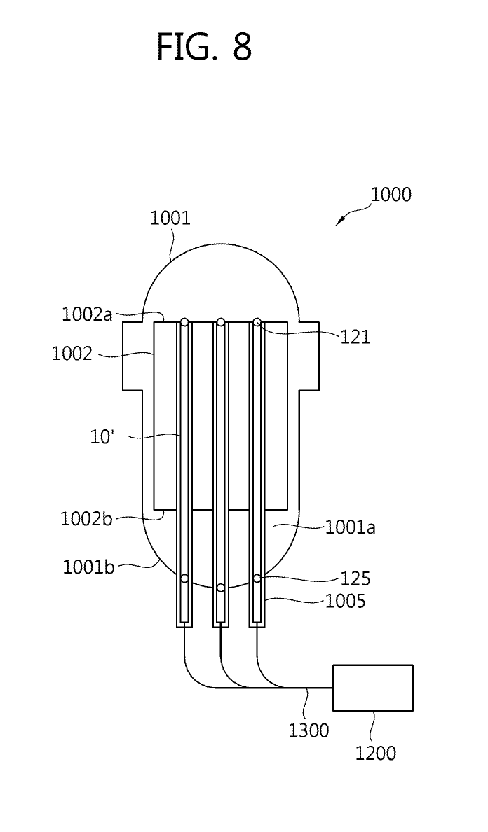

Referring to FIG. 7, the top thermocouple 121 of the thermocouples included in each of the in-core instrument assemblies 10′ measures the temperature of a reactor core top 1002a as in a conventional in-core instrument assembly. Furthermore, the lower thermocouple 125 of the thermocouples included in the in-core instrument assembly 10′ may be installed in the lower cavity 1001a of the nuclear reactor container placed under the reactor core 1002, and may sense the temperature of the lower cavity 1001a of the nuclear reactor container. In another embodiment, referring to FIG. 8, the top thermocouple 121 of the thermocouples included in each of the in-core instrument assemblies 10′ measures the temperature of the reactor core top 1002a as in a conventional in-core instrument assembly. Furthermore, the lower thermocouple 125 may be installed in the lower head 1001b of the nuclear reactor container placed under the reactor core 1002, and may measure the temperature of the lower head 1001b of the nuclear reactor container.

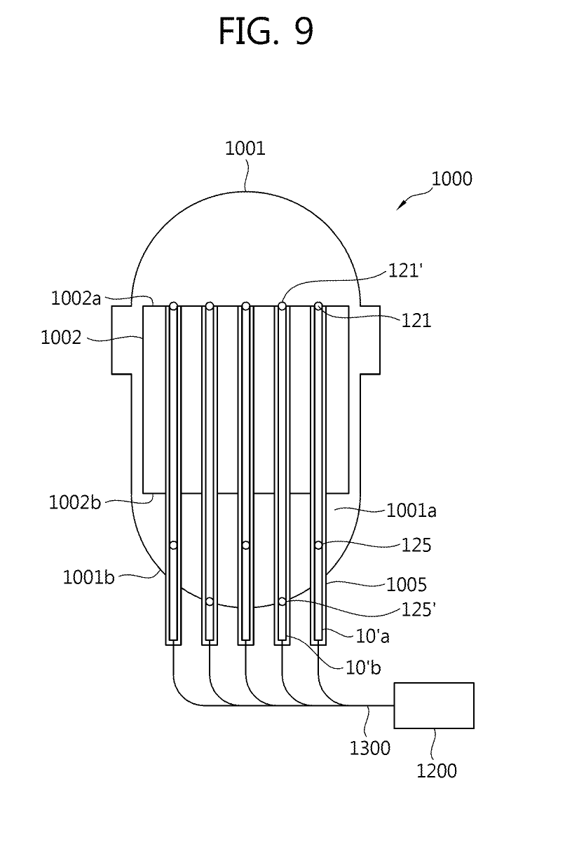

Alternatively, referring to FIG. 9, each of first and second in-core instrument assemblies 10′a and 10′b that are adjacent to each other may include two thermocouples. In this case, the top thermocouples 121 and 121′ measure the temperature of the reactor core top 1002a as in a conventional in-core instrument assembly. In contrast, the lower thermocouple 125 included in the first in-core instrument assembly 10′a may be installed in the lower cavity 1001a of the nuclear reactor container placed under the reactor core 1002, and may measure the temperature of the lower cavity 1001a of the nuclear reactor container. The lower thermocouple 125′ included in the second in-core instrument assembly 10′b is installed in the lower head 1001b of the nuclear reactor container placed under the reactor core 1002, and may measure the temperature of the lower head 1001b of the nuclear reactor container.

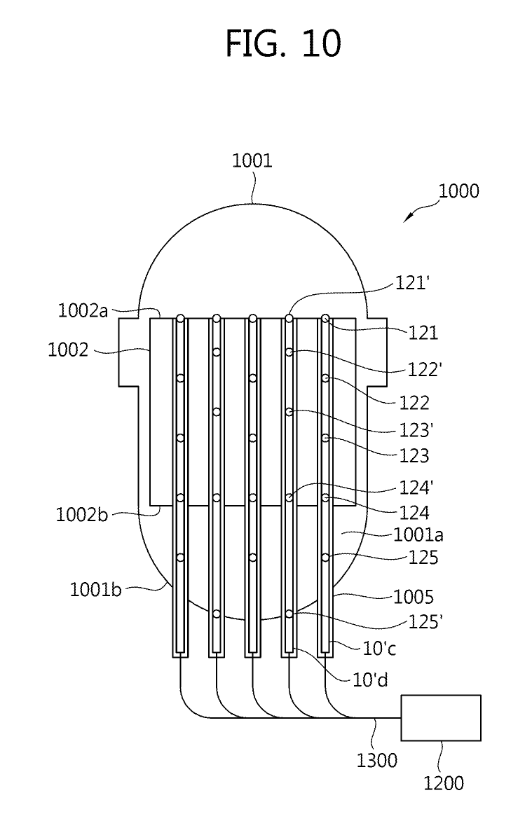

Referring to FIG. 10, in accordance with another embodiment of the present invention, the system 1000 may include two or more in-core instrument assemblies 10′c and 10′d (five in-core instrument assemblies are illustrated in FIG. 10). In this case, the top thermocouples 121 and 121′ of the first and the second in-core instrument assemblies 10′c and 10′d that are adjacent to each other measure the temperature of the reactor core top 1002a as in a conventional in-core instrument assembly 10. The lower thermocouple 125 or 125′ of the first and the second in-core instrument assemblies 10′c or 10′d is alternately installed in the lower cavity 1001a of the nuclear reactor container or the lower head 1001b of the nuclear reactor container placed under the reactor core 1002, and may measure the temperature of the lower cavity 1001a of the nuclear reactor container or the lower head 1001b of the nuclear reactor container. For example, the lower thermocouple 125 of the first in-core instrument assembly 10′c and the lower thermocouple 125′ of the second in-core instrument assembly 10′d may be installed at heights in which they are interested so that the lower thermocouple 125 measures the temperature of the lower cavity 1001a of the nuclear reactor container and the lower thermocouple 125′ measures the temperature of the lower head 1001b of the nuclear reactor container.

Thermocouples 122, 123 and 122′, 123′ that belong to the thermocouples of the in-core instrument assemblies 10′c and 10′d in accordance with another embodiment of the present invention and that are placed within the reactor core 1002 may be disposed adjacent to the dimples of the guide tubes 1005 that form physical contacts between the guide tubes 1005 and the in-core instrument assemblies 10′c and 10′d so that a surrounding temperature is rapidly measured.

Each of the thermocouples may have the most equal space size within the reactor core 1002, and the shape of the space of each thermocouple may be almost a sphere so that the thermocouples measure temperatures at different heights within the reactor core 1002. For example, if first to fifth thermocouples 121, 122, 123, 124, and 125 are included in the first in-core instrument assembly 10′c and first to fifth thermocouples 121′, 122′, 123′, 124′, and 125′ are included in the second in-core instrument assembly 10′d within a nuclear reactor (e.g., APR1400 in Korea) in which a reactor core has a height of 162 inches, both the first thermocouples 121 and 121′ of the first in-core instrument assembly 10′c and the second in-core instrument assembly 10′d may be installed in the reactor core top 1002a. The second thermocouple 122 of the first in-core instrument assembly 10′c may be installed at a dimple location on the upper side of the guide tube 1005, the third thermocouple 123 thereof may be installed at a dimple location on the lower side of the guide tube 1005, and the fourth thermocouple 124 thereof may be installed at the reactor core bottom 1002b. The second thermocouple 122′ of the second in-core instrument assembly 10′d may be disposed at a height between the first thermocouple 121 and second thermocouple 122 of the first in-core instrument assembly 10′c, the third thermocouple 123′ of the second in-core instrument assembly 10′d may be disposed at a height between the second thermocouple 122 and third thermocouple 123 of the first in-core instrument assembly 10′c, and the fourth thermocouple 124′ of the second in-core instrument assembly 10′d may be installed in the reactor core bottom 1002b like the fourth thermocouple 124 of the first in-core instrument assembly 10′c.

As described above, in accordance with another embodiment of the present invention, the heights of the second thermocouples 122 and 122′ and third thermocouples 123 and 123′ of the first in-core instrument assembly 10′c and the second in-core instrument assembly 10′d that are adjacent to each other are disposed so that they cross each other. Accordingly, there is an advantage in that reliability of temperature detection within the reactor core 1002 according to the height can be improved although separate thermocouples are not added.

A K type thermocouple may be used as the thermocouple according to an embodiment of the present invention, and can sense 0˜1260 at a measuring point. The K type thermocouple is a thermocouple in which the ends of different types of metal (e.g., chromel and alumel) are bonded. Minute electromotive force is generated at the other end of the K type thermocouple to which heat has been applied depending on a temperature. The K type thermocouple can measure a temperature by sending the electromotive force. Accordingly, if the heights of two or more K type thermocouples are differently disposed in the length direction (i.e., the lengths of the thermocouples are different) as in an embodiment of the present invention, the K type thermocouples can measure temperatures at different heights.

The conventional in-core instrument assembly measures only the temperature of the reactor core top 1002a, but cannot provide the temperatures of the remaining reactor core 1002 and the lower cavity 1001a or lower head 1001b of the nuclear reactor container. Accordingly, experts need to estimate the internal state of the nuclear reactor based on conditions outside the nuclear reactor. In this process, there are problems in that different views for the estimation need to be adjusted, time is taken for the estimation task, and an error may occur in the estimation results.

The in-core instrument assembly 10′ in accordance with an embodiment of the present invention can measure temperatures from the bottom of a reactor core to the top of the reactor core, can provide the cooling, overheating, oxidation, and bad damage location state, and can determine the seriousness of an accident, deterioration speed, and an accident location. Accordingly, a threat to safety that is attributable to a severe accident can be minimized because a condition within a nuclear reactor and a threat to a safety function can be accurately checked in response to the severe accident and proper measures can be performed on time. In particular, there are advantages in that 1) whether the cooling of a reactor core is proper can be determined and 2) a water level within a nuclear reactor can be estimated based on the temperature of each portion of the reactor core and a change of the temperatures, 3) whether the cooling of the reactor core is appropriate through the inside of the nuclear reactor can be determined based on the degree of the oxidation and bad damage of the reactor core, and 4) the amount of hydrogen that may explode can be estimated based on the degree of the oxidation of the reactor core. Furthermore, a severe accident and the state of molten reactor core disposed under the reactor core can be checked based on a distribution of the temperatures of the thermocouple 125 of the lower cavity 1001a and the lower head 1001b under the nuclear reactor container. Accordingly, a threat and time for the deviation of molten reactor core from a nuclear reactor container can be determined, and important information required to prepare a solution for performing a severe accident reduction strategy, such as securing the integrity of a nuclear reactor through the external cooling of a nuclear reactor can be provided.

The diagnostic unit 1200 in accordance with an embodiment of the present invention may determine bad damage to the reactor core 1002 based on the oxidation of the materials of the reactor core and the time during which the materials are exposed to a high temperature. The amount of oxidation of Zircaloy attributable to a hydration reaction in the representative space of a specific thermocouple and the amount of hydrogen generated in response to the amount of oxidation of Zircaloy are calculated using a hydration reaction equation using the temperature of a corresponding thermocouple after an accident, the time that Zircaloy is exposed to the corresponding temperature, and a steam concentration derived from the water level of a nuclear reactor container. The degree of damage to the reactor core of a representative space can be estimated based on the degree of oxidation of all types of Zircaloy attributable to a hydration reaction and a change in the temperature of a reactor core. Furthermore, a total amount of hydrogen generated in the nuclear reactor 1001 is determined by adding up the amounts of hydrogen generated in the representative spaces of the respective thermocouples 121, 122, 123, 124, and 125.

In accordance with an embodiment of the present invention, 50 to 70 in-core instrument assemblies 10′ may be inserted into the nuclear reactor 1001. 61 in-core instrument assemblies 10′ may be inserted into a nuclear reactor (e.g., APR1400 now operating in Korea).

In accordance with an embodiment of the present invention, each of the thermocouples 121, 122, 123, and 124 of the reactor core 1002 has a specific space formed according to the same distance rule with another adjacent thermocouple within the reactor core 1002. This is defined as the representative spaces of a specific thermocouple, and the amount of fuel cladding that is included in a corresponding representative space and that generates a hydration reaction is also defined.

A method for monitoring a nuclear reactor after a severe accident in accordance with an embodiment of the present invention may include steps of disposing two or more thermocouples in an in-core instrument assembly, disposing the two or more thermocouples at different heights in a length direction, inserting the two or more in-core instrument assemblies into a nuclear reactor, and measuring the temperature of the reactor core through the thermocouples.

The method for monitoring a nuclear reactor after a severe accident in accordance with an embodiment of the present invention may further include determining at least one of whether the reactor core has been damaged, the location of a damaged reactor core, the state in which molten reactor core has been rearranged, and the time when the molten reactor core penetrates the nuclear reactor based on a temperature within the nuclear reactor measured in the step of measuring the temperatures at the different heights within the nuclear reactor through the thermocouples.

In this case, at least one of whether the reactor core has been damaged, the location of the damaged reactor core, and the amount of hydrogen generated in the nuclear reactor may be based on the oxidation of the materials of the reactor core and the time during which the materials are exposed to a high temperature. This has been described above in detail.

Alternatively, at least one of the state in which molten reactor core has been rearranged and the time when the molten reactor core penetrates the nuclear reactor may be based on the temperature of the lower cavity or the lower head under the nuclear reactor. This has been described above in detail.

In accordance with the multi-thermocouple in-core instrument assembly according to an embodiment of the present invention, the internal state of a nuclear reactor can be diagnosed more accurately and the utilization of an apparatus can be maximized because temperature information at different heights within the nuclear reactor is provided using a plurality of thermocouple having temperature-measuring points at different heights.

The system and method for monitoring the internal state of a nuclear reactor after a severe accident in accordance with an embodiment of the present invention are advantageous in that they can provide support so that the entry of a severe accident and a crucial decision for a power plant can be rapidly determined based on the seriousness of an accident and progress speed by monitoring a temperature in each portion of a reactor core and the water level of a nuclear reactor container.

Furthermore, the system and method for monitoring the internal state of a nuclear reactor after a severe accident in accordance with an embodiment of the present invention are advantageous in that they can provide temperature information about the inside of a nuclear reactor although a reactor core exit temperature measuring instrument initially used in a severe accident is lost by monitoring a temperature in each portion of a reactor core.

Furthermore, the system and method for monitoring the internal state of a nuclear reactor after a severe accident in accordance with an embodiment of the present invention are advantageous in that they can determine a threat to a reactor core cooling function, that is, a nuclear reactor safety function, and provide information by which whether an existing safety action is effective because whether a corresponding portion is cooled or overheated and cooling or overheating speed of the corresponding portion can be checked by monitoring a temperature in each portion of the reactor core.

Furthermore, the system and method for monitoring the internal state of a nuclear reactor after a severe accident in accordance with an embodiment of the present invention are advantageous in that they can provide information by which whether an operation for inputting a coolant to a nuclear reactor in order to cool a reactor core from the bad damage state of each portion is effective for the reactor core when a severe accident is generated in a nuclear power plant.

Furthermore, the system and method for monitoring the internal state of a nuclear reactor after a severe accident in accordance with an embodiment of the present invention are advantageous in that they can provide information required for a hydrogen removal operation within a nuclear reactor containment building and required to prevent the explosion of hydrogen based on the amount of hydrogen generated from the oxidation of a reactor core when a severe accident is generated in a nuclear power plant.

Furthermore, the system and method for monitoring the internal state of a nuclear reactor after a severe accident in accordance with an embodiment of the present invention are advantageous in that they can optimally determine the time when the external cooling operation of a nuclear reactor is started based on the state in which molten reactor core has been rearranged in the lower cavity of a nuclear reactor container according to a lapse of a severe accident and the state in which molten reactor core has deviated from the lower head of the nuclear reactor container and can contain molten reactor core within the barrier of the nuclear reactor container.

What is claimed is:

1. A multi-thermocouple in-core instrument assembly, wherein:
the in-core instrument assembly comprises a signal compensation detector, thermocouples, and a plurality of neutron detectors disposed between a center pipe having a circular section and an external protection pipe, and
the thermocouples have temperature-measuring points at different heights.

2. The in-core instrument assembly of claim 1, wherein:
a number of the signal compensation detector is one, a number of the neutron detectors is five, and a number of the thermocouples is two to five, and
if four or less thermocouples are installed, a space in which the thermocouple is not installed is filled with filler cables.

3. The in-core instrument assembly of claim 2, wherein the thermocouple or the filler cables and the neutron detector are alternately disposed.

4. The in-core instrument assembly of any one of claims 1 to 3, wherein an empty space is filled with filler cables if the empty space is formed above the thermocouple.

5. The in-core instrument assembly of claim 4, wherein each of the thermocouples is formed by bonding adjacent wires made of different materials.

6. The in-core instrument assembly of claim 5, wherein the wires made of different materials comprise a chromel wire and an alumel wire.

7. A system for monitoring an internal state of a nuclear reactor after a severe accident, the system comprising:
an in-core instrument assembly inserted into the nuclear reactor and configured to measure neutrons and a temperature within the nuclear reactor; and
a diagnostic unit configured to determine a state of the nuclear reactor based on a temperature measured by the in-core instrument assembly,
wherein the in-core instrument assembly comprises two or more thermocouples, and
two or more in-core instrument assemblies are inserted and disposed in the nuclear reactor at a specific interval.

8. The system of claim 7, wherein the two or more thermocouples have different heights in a length direction.

9. The system of claim 8, wherein the diagnostic unit determines at least one of whether a reactor core has been damaged, a location of a damaged reactor core, an amount of hydrogen generated in the nuclear reactor, a state in which molten reactor core has been rearranged, and a time when molten reactor core penetrates the nuclear reactor based on a temperature measured by the two or more thermocouples.

10. The system of claim 9, wherein at least one of whether the reactor core has been damaged, the location of the damaged reactor core, and the amount of hydrogen generated in the nuclear reactor is determined based on an oxidation of materials of the reactor core and a time during which the materials are exposed to a high temperature.

11. The system of claim 9, wherein at least one of the state in which the molten reactor core has been rearranged and the time when the molten reactor core penetrates the nuclear reactor is determined based on a temperature of a lower cavity under the nuclear reactor or a lower head.

12. A method for monitoring an internal state of a nuclear reactor after a severe accident using an in-core instrument assembly, the method comprising steps of:
(A) disposing two or more thermocouples in the in-core instrument assembly;
(B) disposing the two or more thermocouples at different heights in a length direction;
(C) inserting the two or more in-core instrument assemblies into the nuclear reactor; and
(D) measuring temperatures at the different heights within the nuclear reactor through the thermocouples.

13. The method of claim 12, further comprising a step of (E) determining at least one of whether a reactor core has been damaged, a location of a damaged reactor core, an amount of hydrogen generated in the nuclear reactor, a state in which molten reactor core has been rearranged, and a time when molten reactor core penetrates the nuclear reactor based on a temperature within the nuclear reactor measured the step (D).

14. The method of claim 13, wherein at least one of whether the reactor core has been damaged, the location of the damaged reactor core, and the amount of hydrogen generated in the nuclear reactor is determined based on an oxidation of materials of the reactor core and a time during which the materials are exposed to a high temperature.

15. The method of claim 13, wherein at least one of the state in which the molten reactor core has been rearranged and the time when the molten reactor core penetrates the nuclear reactor is determined based on a temperature of a lower cavity under the nuclear reactor or a lower head.
